(19) United States
(12) Patent Application Publication
(10) Pub. No.: US 2012/0308956 A1
(43) Pub. Date: Dec. 6, 2012

(54) Multi-Piece Dental Ultrasonic Tip

(76) Inventors: James A. DeVengencie, Grafton, OH (US); F. Kris Olsen, Whitefish Bay, WI (US); Spanky Raymond, Akron, OH (US)

(21) Appl. No.: 13/421,331

(22) Filed: Mar. 15, 2012

Related U.S. Application Data
(60) Provisional application No. 61/491,752, filed on May 31, 2011.

(51) Int. Cl. A61C 3/03; A61C 19/06; A61C 17/02

(52) U.S. Cl. 433/86; 433/119; 433/215

(57) ABSTRACT

An ultrasonic dental instrument provides a hand piece with an ultrasonic generator communicating with a separable base and tip that when assembled provide mechanical rigidity and the conduction of ultrasonic energy from the ultrasonic generator to a distal portion of the tip but which may be separated for individual replacement and manufacture.

### CROSS REFERENCE TO RELATED APPLICATION

This application claims the benefit of U.S. provisional application 61/491,752 filed May 31, 2011 and hereby incorporated by reference.

### BACKGROUND OF THE INVENTION

The present invention relates to the field of dentistry, and in particular to an improved ultrasonic tip for operating within and on the surface of the crown and root of a tooth.

Ultrasonic tips can have multiple uses in dentistry. They are used to remove tooth structure within the pulp chamber to provide better root canal access, to look for calcified canals and create root end preparations in endodontic surgery. Ultrasonic tips can also be used to remove separated files and posts within a canal. Ultrasonic tips currently available on the market allow the instrument to be used in a wet or dry field.

Ultrasonic tips are used by dental hygienists and dentists to remove hard deposits from teeth during prophylaxis and periodontal procedures. The use of ultrasonic tips in lieu of hand scaling to remove hard calculus deposits from teeth reduces the treatment time, increases treatment efficiency, provides better access to problem areas and reduces hand fatigue of the operator. Ultrasonic tips allow the safe removal of certain calculus deposits that otherwise would not be able to be removed by hand scaling. The use of dental burs in a high speed or low speed hand piece to remove calculus deposits can be much more damaging to the tooth.

In endodontics, the use of ultrasonic tips instead of carbide dental burs in high or low speed hand pieces to refine the access cavity or to look for canals has several clinical advantages. First, the head of the ultrasonic hand piece is smaller than the high or low speed hand piece; therefore, it will not obscure the line of sight for the operator. Secondly, the size of the ultrasonic tip is smaller than a bur and thus will remove smaller increments of tooth structure while allowing better control of the cutting action by the dentist. Lastly, the ultrasonic action in conjunction with water flowing over the tip creates a cavitation effect. This effect causes the irrigants to bubble and generate shock waves to enable the disruption of pulp tissue remnants and calcified tissue. This is the main reason why after the use of an ultrasonic tip to remove pulp chamber debris, it is a much cleaner surface than when a bur is used for the same procedure.

One of the innate problems with nickel-titanium rotary file usage is the chance of file breakage due to cyclic fatigue and/or torsional stress. Ultrasonic tips are used clinically to attempt separated file removal or bypass through trenching around the file.

Nonsurgical endodontic retreatment can require the removal of a post in order to gain proper access to a canal. The use of ultrasonic tips can create the necessary vibration to disrupt the cement around a post. Ultrasonic tips also provide a conservative removal of tooth as compared to a dental bur while trenching around a post in order to loosen it for removal.

The use of ultrasonic tips for endodontic surgery allows the clinician to resect the root-end with minimal or no bevel rather than at the 45° angle needed to allow access for the mini or slow-speed hand piece. The 45° root resection reduces the depth of the actual root-end preparation because the bur is not able to create a class I cavity preparation to the recommended 3 mm depth. This is achieved with the use of an ultrasonic tip because its size and angle allows access for the root end to have no or minimal bevel and thus the tip is able to better cut down the longitudinal axis of the root.

Currently, ultrasonic tips are manufactured as a one-piece metal instrument that may be attached by a thread or other means to a hand piece containing the ultrasonic generator (typically piezoelectric or magnostrictive element). Such tips provide a substantially continuous acoustic pathway between the hand piece and a distal portion of the tip that is predominantly used for the dental work. Often the tip is curved or angled to displace the hand piece out of the line of sight of the operator. The distal end of the tip may be slender to provide for improved clearance around the dental structures and within the mouth and may include one or more channels to provide for the passage of irrigants. Although the tips are constructed of sturdy materials, these constraints and features often result in tip breakage at considerable expense to the dentist.

### SUMMARY OF THE INVENTION

The present invention provides an ultrasonic tip that separates the distal portion of the tip from a base portion of the tip communicating with the hand piece to significantly decrease the cost of manufacture of the tip and of replacement of the tip in the event of breakage. The present inventors have determined that added releasable mechanical connectors between the multiple portions of the tip necessary for this modularity may nevertheless transmit sufficient acoustic energy for effective operation of the tip.

Specifically, the present invention provides an ultrasonic dental instrument for use with a hand piece having an ultrasonic generator producing ultrasonic acoustic waves. The ultrasonic dental instrument includes an elongated ultrasonically conductive metal tip having a distal end formed for treatment of a tooth by ultrasonic vibration and an ultrasonically conductive base having a first attachment element at a proximal end engaging a distal end of the ultrasonic generator of the hand piece and having a second attachment element at a distal end engaging a proximal end of the ultrasonically conductive tip. The first and second attachment elements releasably assemble the base and tip together and fix the base to the ultrasonic generator for conduction of ultrasonic acoustic energy from the ultrasonic generator through the base into the tip to the distal end of the tip.

It is thus a feature of at least one embodiment of the invention to allow separation of the components of the ultrasonic tip for improved replaceability.

The first and second attachment elements may include inter-engaging threads between the base and the ultrasonic generator and between the base and the tip.

It is thus a feature of at least one embodiment of the invention to provide a mechanically robust and intuitive assembly system that may nevertheless provide for suitable ultrasonic coupling through multiple joints formed by such assembly.

The axis of engagement of the inter-engaging threads of the second attachment element may fix the tip to extend at an angle with respect to an extent of the base.

It is thus a feature of at least one embodiment of the invention to provide for simplified manufacturing and thus lower cost of angled instruments by allowing separate manufacturing of the instrument components of the tip and base.

The second attachment element may include an angulation element releasably attached to the tip.

It is thus a feature of at least one embodiment of the invention to allow for multiple different angulations to be obtained by simple replacement of a single angulation element separate from the base and tip.

The angulation element may be releasably attached to the tip by inter-engaging threads.

It is thus a feature of at least one embodiment of the invention to provide a uniform attachment method through multiple joints between the base and angulation element and angulation element and tip.

The inter-engaging threads may be locking threads.

It is thus a feature of at least one embodiment of the invention to provide an assembly method that is simple yet resistant to separation under ultrasonic energy.

The locking threads may be selected from the group consisting of tapered threads and asymmetric threads.

It is thus a feature of at least one embodiment of the invention to provide locking threads that may be readily manufactured by modification of the threads themselves without the need for locking adhesives or polymers.

The tip and base may include wrench flats for receiving a wrench for assembling the first and second attachment elements to releasably fix the base to the ultrasonic generator and the base to the tip.

It is thus a feature of at least one embodiment of the invention to provide a system that may be assembled in the field to allow a user to flexibly customize the dental instrument from a collection of parts.

At least one of the first and second attachment elements may include a resilient washer.

It is thus a feature of at least one embodiment of the invention to provide a method of locking and sealing the joint.

The ultrasonic generator, base and tip may have internal channels for communicating water therethrough and the first and second attachment elements may include bridging channels joining the channels of the ultrasonic generator and base and of the base and tip when the base is attached to the ultrasonic generator and the tip is attached to the base.

It is thus a feature of at least one embodiment of the invention to provide an attachment and assembly method conducive to systems that require a continuous internal channel for irrigation.

The tip may be coated with a nonmetallic material.

It is thus a feature of at least one embodiment of the invention to provide ultrasonic instruments employing composite materials.

The coating may be an abrasive.

It is thus a feature of at least one embodiment of the invention to provide the benefits of the present invention with abrasive instruments.

The tip may be substantially axially symmetric or may extend along a curve from the proximal to the distal end.

It is thus a feature of at least one embodiment of the invention to provide a system that may be used with a variety of different types of tips.

These particular features and advantages may apply to only some embodiments falling within the claims and thus do not define the scope of the invention.

### BRIEF DESCRIPTION OF THE DRAWINGS

FIG. 1 is an exploded cross-sectional view of a first embodiment of the present invention including a hand piece, base, angulation element, and tip that may be assembled together to provide a dental instrument;

FIGS. 2a-c are a set of cross-sectional views of an angulation element of the tip providing for different tip angles;

FIG. 3 is a fragmentary cross-section of a two-piece design in which the angulation element is permanently affixed to the base;

FIG. 4 is a figure similar to that of FIG. 3 showing an alternative embodiment of the two-piece design in which the angulation element is a permanently affixed to the tip;

FIG. 5 is a fragmentary perspective view of the base, angulation element, and tip showing the location of wrench flats for assembling them together;

FIG. 6 is a fragmentary cross-sectional view of an alternative attachment element for joining the base to the tip;

FIG. 7 is a figure similar to that of FIG. 6 showing use of a washer for locking and sealing the tip and base together for good ultrasonic coupling; and

FIG. 8 is a side elevational view of a base and assembled tip with a curved extension.

### DETAILED DESCRIPTION OF THE PREFERRED EMBODIMENT

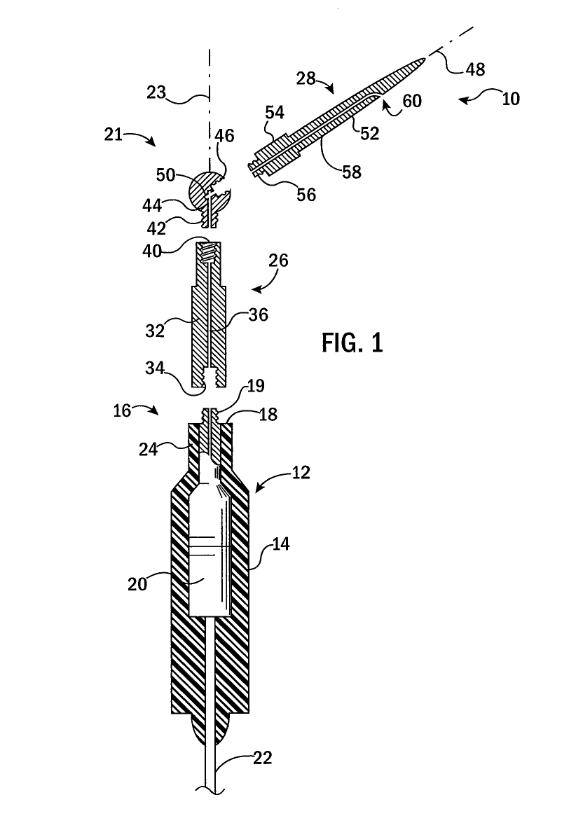

Referring now to FIG. 1, an ultrasonic dental instrument 10 may include an ultrasonic hand piece 12 providing an outer housing 14, for example, of an insulating thermoplastic that may be comfortably gripped by a user for use in a dental treatment. The outer housing 14 may expose at a distal end 16 a vibrating shaft 18 receiving ultrasonic energy from an internal ultrasonic generator 20 held within the housing 14. The exposed end of the vibrating shaft 18 may provide a threaded boss 19 projecting along an axis 23 aligned with the extent of the housing 14 that may be used to attach the hand piece 12 to a tool 21 as will be described below.

The ultrasonic generator 20 may be a piezoelectric or magnetostrictive type generator of the type known in the art receiving modulated electrical power via a hand piece cord 22 communicating with a remote power source. The hand piece cord 22 may also provide a feed for cooling water that may pass through a channel 24 in the vibrating shaft 18 and centered within the boss 19 to open therefrom. The shaft 18 and threaded boss 19 typically may be a metallic material, such as stainless steel, for good conduction of acoustic energy.

The tool 21 includes at least two portions of an ultrasonically conductive base 26 and ultrasonically conductive tip 28 that may be attached together by an angulation element 30 that is also ultrasonically conductive. The base 26 may provide for a metallic shaft 32 extending along the axis 23 and having a threaded bore 34 at a proximal end that may threadably receive the threaded boss 19 to mechanically attach metallic shaft 32 to the shaft 18 while providing a low acoustic impedance interface for the conduction of ultrasonic energy into the shaft 32. The shaft 32 may further include an internal channel 36 aligned with and communicating with channel 24 when the metallic shaft 32 is attached to the shaft 18.

A distal end of the metallic shaft 32 provides a threaded bore 40 opposed along axis 23 from threaded bore 34 that may receive a threaded boss 42 of the angulation element 30. The channels 36 may be exposed at the base of the threaded bore 40 to communicate with a corresponding channel 44 within the angulation element 30 when the angulation element 30 is attached to the metallic shaft 32 by an inter-engaging of the threads of threaded boss 42 and threaded bore 40.

The angulation element 30 may, for example, be a metallic sphere having the threaded boss 42 extending downward along axis 23 and may have a threaded bore 46 extending at an angle from axis 23 along axis 48. A secondary channel 50 may extend from a base of the threaded bore 46 to intersect channel 44 to provide a continuous path of cooled water through channel 44 and then through channel 50 into the bore 46.

The tip 28 may provide for an elongate conductive shaft 52 extending along axis 48 from a collar 54 having a threaded boss 56 extending toward the angulation element 30 to be received thereby within the threaded bore 46. An internal channel 58 extending axially along axis 48 within the tip 28 may pass through the shaft 52 and the threaded boss 56 to communicate at the distal end of the tool tip 28 with the channel 50 and to proceed to an orifice 60 located near or at the proximal end of the tip 28.

One or more of the threads of boss 42, bore 40, bore 46, and boss 56 may be locking threads providing either a cone shaped helix (like a pipe thread) or a helical asymmetry (meaning a deviation from a mirror symmetry along an axial cross-section such as provided by the Spiralock™ thread form having a wedge ramp on half of the threaded surfaces) or a thread insert deformed by engagement of the threads.

It will be appreciated that breakage or need for a different type of tip 28 may be accommodated by replacing of the tip 28 without the need to replace the angulation element 30 and/or the base 26. Further, it will be appreciated that in this simple embodiment each of the elements of the base 26, angulation element 30, and tip 28 may be readily fabricated by simple manufacturing processes, for example, using a metal lathe suitable for making axially symmetric parts and standard boring and threading operations.

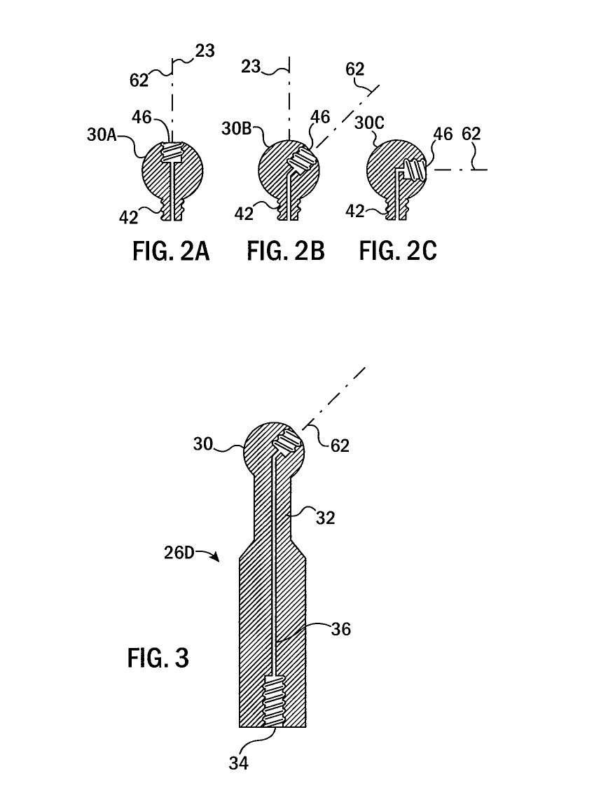

Referring now to also FIGS. 2a-2c, multiple angulation elements 30a-30c may be provided to allow a variety of angles of the axis 48 of the tip 28 with respect to axis 23 simply by changing the angulation element 30 without the need for multiple different bases 26 or tips 28 for each angle. Each of these angulation elements 30a-30b may provide for a corresponding threaded boss 42 extending downward along axis 23 but with an axis 62 of threaded bore 46 providing any angle between alignment with axis 23 and perpendicular to axis 23 at 15° increments therebetween. It will be appreciated that the axis 62 of the bore 46 determines axis 48.

Referring now to FIG. 3, a variation on the above embodiment provides a unitary metal shaft 32 and angulation element 30 such as may provide for different axes 62 by replacement of the base 26 and angulation element 30 together. In this case, the angulation element 30 is part of the base 26. The need for a larger element of replacement may be offset desirably by elimination of one additional joint (between the angulation element 30 and the shaft 32) to reduce ultrasound attenuation and assembly time. In this embodiment, multiple tips and replacement of tips 28 are still readily provided.

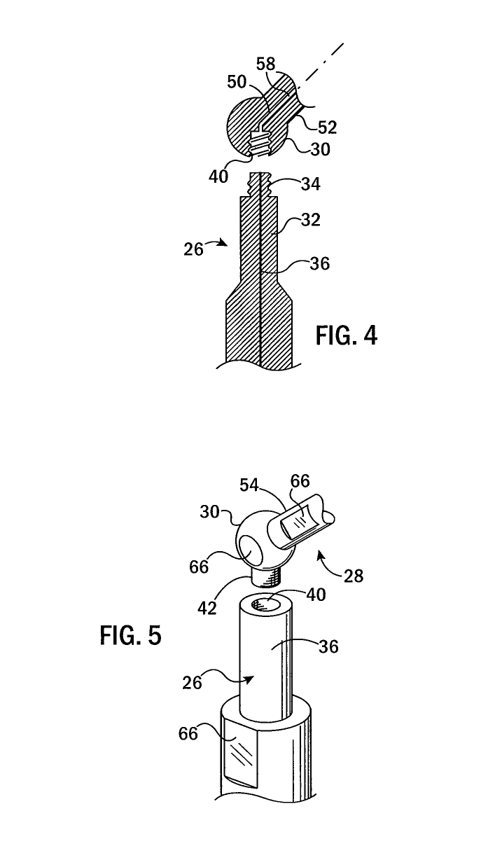

Referring now to FIG. 4, alternatively, the angulation element 30 may be a unitary portion of the metal shaft 52 and the joint provided between the angulation element 30 and the metal shaft 32. In this embodiment, the angulation element 30 is part of the metal tip 28. In this embodiment, a reversal of the location of the boss 42 to the metal shaft 32 and the boss 42 to the angulation element 30 is shown by way of an alternative embodiment. It will be appreciated that this reversal of male and female threads may be provided at any of the connections described.

Referring now to FIG. 5, each of the base 26, angulation element 30, and tip 28 may be provided with wrench flats 66 being diametrically opposed tangential surfaces (with respect to axes 23 or 48) on the outer circumference of these generally round elements to provide purchase for the opposed surface of the open end wrench or the like that may be provided to assist in tightening the threaded connection between the base 26 and angulation element 30, for example, and the threaded connection between the angulation element 30 and the tip 28.

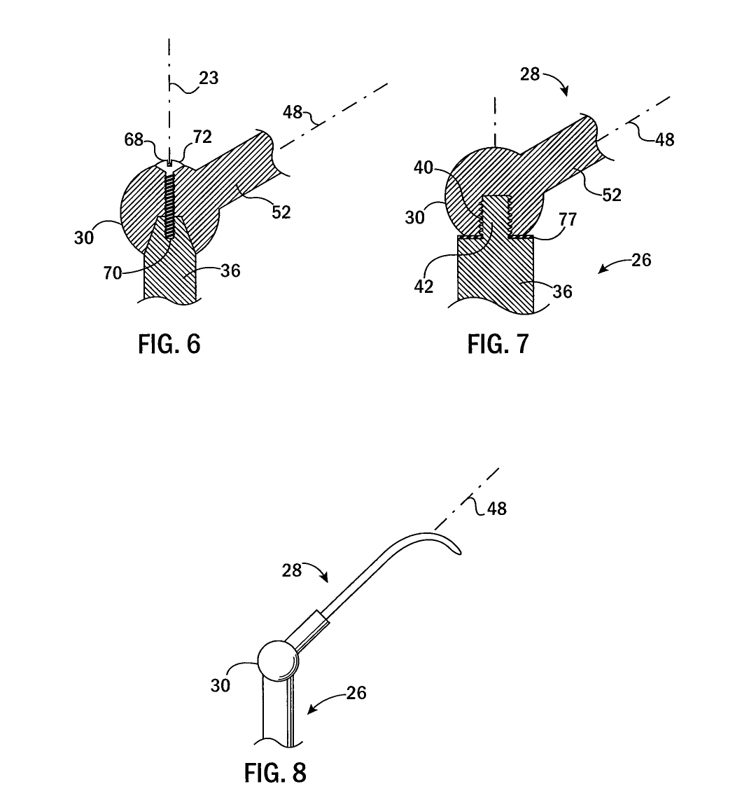

Referring now to FIG. 6, it will be appreciated that the threaded connection between the various elements, for example the metal shaft 32 and the angulation element 30, may be provided, for example, by a separate machine screw 68 passing downward through the angulation element 30, along axis 23 and through a threaded bore 70 in an upper end of the metallic shaft 32. The interface between the angulation element 30 and the metal shaft 32 may, for example, be a frustoconical interface ensuring close connection between the materials of the metal shaft 32 and angulation element 30 when drawn together by tightening of the machines screw 68 pulling a head 72 of the machine screw downward to pull the angulation element 30 tightly against the metal shaft 32. Thus the threaded elements need not be integral to the elements that they connect.

Referring now to FIG. 7, any one of the threaded joints between the hand piece 12 and the base 26 or between the base 26 and the angulation element 30 or between the angulation element 30 and the tip 28 may be augmented by means of a compression washer 77, for example a wave washer or a lock washer or flexible o-ring, providing for both sealing and controlled torsional engagement.

Referring now to FIG. 8, it will be appreciated that a variety of different tool tips 28 may be used with the present invention including those which curve with respect to axis 48. Such curved tips are slightly more complicated to fabricate and will typically involve a bending operation but are still greatly simplified by the multipart construction of the present invention.

The metal used in the components of the tool 21 may be, for example, stainless steel or titanium. Generally, the tip 28 will be sized to be substantially rigid, in contrast to a nickel-titanium endodontic file, for example, to resist bending along the axis 48. The tip 28 will further differ from a file by a lack of flutes characteristic of a file. The distal end of the tip 28 may however be coated with an abrasive such as diamond.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

What we claim is:

1. An ultrasonic dental instrument for use with a hand piece having an ultrasonic generator producing ultrasonic acoustic waves comprising:
an elongate ultrasonically conductive tip having a distal end formed for treatment of a tooth by ultrasonic vibration;
an ultrasonically conductive base having a first attachment element at a proximal end engaging a distal end of the ultrasonic generator of the hand piece and having a second attachment element at a distal end engaging a proximal end of the ultrasonically conductive tip; and
wherein the first and second attachment elements releasably assemble the base and tip together and fix the base to the ultrasonic generator for conduction of ultrasonic acoustic energy from the ultrasonic generator through the base into the tip to the distal end of the tip.

2. The ultrasonic dental instrument of claim 1 wherein the first and second attachment elements include inter-engaging threads between the base and ultrasonic generator and between the base and the tip.

3. The ultrasonic dental instrument of claim 2 wherein an axis of engagement of the inter-engaging threads of the second attachment element may fix the tip to extend at an angle with respect to an angular extent of the base.

4. The ultrasonic dental instrument of claim 3 wherein the second attachment element includes an angulation element releasably attached to the tip.

5. The ultrasonic dental instrument of claim 4 wherein the angulation element is releasably attached to the tip by inter-engaging threads.

6. The ultrasonic dental instrument of claim 2 wherein the inter-engaging threads are locking threads.

7. The ultrasonic dental instrument of claim 6 wherein the locking threads are selected from the group consisting of tapered threads and helically asymmetric threads.

8. The ultrasonic dental instrument of claim 7 wherein the tip and base include wrench flats for receiving a wrench for assembling the first and second attachment elements to releasably fix the base to the ultrasonic generator and the base to the tip,

9. The ultrasonic dental instrument of claim 7 wherein at least one of the first and second attachment elements includes a resilient washer.

10. The ultrasonic dental instrument of claim 1 wherein the ultrasonic generator, base and tip have internal channels for communicating water therethrough and the first and second attachment elements include bridging channels joining the channels of the ultrasonic generator and base and of the base and tip when the base is attached to the ultrasonic generator and the tip is attached to the base.

11. The ultrasonic dental instrument of claim 1 wherein the tip is a metal coated with a nonmetallic coating.

12. The ultrasonic dental instrument of claim 11 wherein the coating is an abrasive.

13. The ultrasonic dental instrument of claim 1 wherein the tip is substantially axially symmetric.

14. The ultrasonic dental instrument of claim 1 wherein the tip extends along a curve from the proximal to the distal end.

15. The ultrasonic dental instrument of claim 1 wherein further including the ultrasonic base and the ultrasonic generator.

16. A method of treating a patient with an ultrasonic dental instrument having:
a set of elongate ultrasonically conductive tips having a distal end formed for treatment of a tooth by ultrasonic vibration;
an ultrasonically conductive base having a first attachment element at a proximal end engaging a distal end of the ultrasonic generator of a hand piece and having a second attachment element at a distal end engaging a proximal end of the ultrasonically conductive tip; and
wherein the first and second attachment elements releasably fix the base to an ultrasonic generator and the base to the tip respectively for conduction of ultrasonic acoustic energy from the ultrasonic generator through the base into the tip to the distal end of the tip; the method comprising the steps of:
(a) selecting an ultrasonic tip from the set of ultrasonic tips;
(b) attaching the selected ultrasonic tip to the conductive base using the second attachment element;
(c) attaching the base to the ultrasonic generator using the first attachment element; and
(d) treating the patient by conducting ultrasonic vibrations from the ultrasound generator through the base to the tip and applying the tip to a tooth structure.
